(19) United States
(12) Patent Application Publication
(10) Pub. No.: US 2011/0148509 A1
(43) Pub. Date: Jun. 23, 2011

(54) Techniques to Reduce Charge Pump Overshoot

(76) Inventor: Feng Pan, Fremont, CA (US)

(21) Appl. No.: 12/640,820

(22) Filed: Dec. 17, 2009

(51) Int. Cl. G05F 1/10

(52) U.S. Cl. 327/536

(57) ABSTRACT

A charge pump system for supplying an output voltage to a load is described. The charge pump system includes a charge pump connected to receive an input voltage generate from it the output voltage. The system also includes regulation circuitry connected to receive the output voltage and a reference voltage, where the regulation circuitry is connected to the charge pump to regulate the output voltage based upon the values of the reference voltage and the output voltage. During ramp up or a recovery operation the output voltage is initially regulated according to a first level and subsequently regulated to a second level higher than the first level, the second level corresponding to a desired regulated output voltage.

### FIELD OF THE INVENTION

This invention pertains generally to the field of charge pumps and more particularly to the reduction of overshoot during ramp-up or the recovery mode charge pumps.

### BACKGROUND

Charge pumps use a switching process to provide a DC output voltage larger than its DC input voltage. In general, a charge pump will have a capacitor coupled to switches between an input and an output. During one clock half cycle, the charging half cycle, the capacitor couples in parallel to the input so as to charge up to the input voltage. During a second clock half cycle, the transfer half cycle, the charged capacitor couples in series with the input voltage so as to provide an output voltage twice the level of the input voltage. This process is illustrated in FIGS. 1a and 1b. In FIG. 1a, the capacitor 5 is arranged in parallel with the input voltage V_{IN} to illustrate the charging half cycle. In FIG. 1b, the charged capacitor 5 is arranged in series with the input voltage to illustrate the transfer half cycle. As seen in FIG. 1b, the positive terminal of the charged capacitor 5 will thus be 2* V_{IN} with respect to ground.

Charge pumps are used in many contexts. For example, they are used as peripheral circuits on EEPROM, flash EEPROM and other non-volatile memories to generate many of the needed operating voltages, such as programming or erase voltages, from a lower power supply voltage. A number of charge pump designs, such as conventional Dickson-type pumps, are know in the art. But given the common reliance upon charge pumps, there is an on going need for improvements in pump design, particularly with respect to trying to reduce the amount of layout area and the current consumption requirements of pumps.

FIG. 2 is a top-level block diagram of a typical charge pump arrangement. The designs described here differ from the prior art in details of how the pump section 201. As shown in FIG. 2, the pump 201 has as inputs a clock signal and a voltage Vreg and provides an output Vout. The high (Vdd) and low (ground) connections are not explicitly shown. The voltage Vreg is provided by the regulator 203, which has as inputs a reference voltage Vref from an external voltage source and the output voltage Vout. The regulator block 203 regulates the value of Vreg such that the desired value of Vout can be obtained. The pump section 201 will typically have cross-coupled elements, such at described below for the exemplary embodiments. (A charge pump is typically taken to refer to both the pump portion 201 and the regulator 203, when a regulator is included, although in some usages “charge pump” refers to just the pump section 201.)

FIG. 3 illustrates schematically a charge pump typical of the prior art. The charge pump receives an input at a voltage Vᵢₙ, and provides an output at a higher voltage Vₒᵤₜ by boosting the input voltage progressively in a series of voltage multiplier stages. The voltage output is supplied to a load, for example the word line of an EPROM memory circuit. FIG. 3 also shows a feedback signal from the load to the charge pump, but without explicitly showing the regulator block. Most charge pump arrangements will typically have two such branches of one of more stage that alternately provided Vout as the clock signals alternate.

FIG. 4 schematically illustrates a voltage multiplier stage as commonly implemented in the prior art. The stage pumps charge in response to a clock signal shown as “CLK.” When the clock signal is at a low portion of the clock cycle (e.g. 0V) the driver circuit output is LOW. This means that the lower terminal of capacitor C is at 0 volts. An input supplies a voltage Vₙ₋₁ through the diode D (typically a diode connected transistor) and provides approximately Vₙ₋₁ to the upper terminal of C (ignoring the voltage drop across the diode, D). This will deposit a charge Q on the capacitor, where Q=CVₙ₋₁ When the clock signal transitions to a high state the output of the driver circuit is high, for example V_{CLK} and so the lower terminal of C is at V_{CLK}. This will force the upper terminal of C to be (Vₙ₋₁+ΔV_{CLK}) since charge, Q, is conserved and C is constant. Thus the output voltage of the voltage multiplier stage is: Vₙ=Vₙ₋₁+ΔV_{CLK}. The driver will drive one side of the capacitor to Vclk, however because of parasitic capacitance the other side will be increased by ΔV_{CLK}, a voltage less than V_{CLK}.

FIG. 5 illustrates the regulated output voltage of a typical charge pump of the prior art while maintaining a voltage, for example the programming voltage of a flash memory Vₚₚ. When the output voltage falls below a margin of Vₚₚ, the pump is turned on by the regulator. The pump delivers a high current to the load and drives the voltage higher than Vₚₚ. The pump then switches off in response to a feedback signal from the load. The voltage on the load then drops due to leakage current until it reaches a predetermined voltage, lower than Vₚₚ by a fixed amount. Then the charge pump switches on again. This cycle produces the ripples in voltage shown. If these ripples (shown by ΔV) are large they may cause problems; for the Vₚₚ example, this can be manifested by problems such as by programming a floating gate to the wrong voltage level, or by causing a greater variation in program levels.

The recovery mode of a charge pump is when, after the application of a load, the output of the pump is ramped-up to the voltage level at which the output is to be regulated. This requires a large current to charge the load to the required voltage as rapidly as possible. After the output voltage ramps up to the regulation level, the output will typically overshoot the desired regulation level, placing stress on the circuit elements.

### SUMMARY OF THE INVENTION

According to a first set of aspects, a charge pump system for supplying an output voltage to a load is presented. The system includes a charge pump connected to receive an input voltage generate from it the output voltage. The system also includes regulation circuitry connected to receive the output voltage and a reference voltage, where the regulation circuitry is connected to the charge pump to regulate the output voltage based upon the values of the reference voltage and the output voltage. During ramp up or a recovery operation the output voltage is initially regulated according to a first level and subsequently regulated to a second level, where the second level is higher (or of greater amplitude) than the first level and corresponds to a desired regulated output voltage.

Other aspects present a method of operating a charge pump system to provide an output voltage at an output. A load is applied the output and, in response, the charge pump is operated during ramp up or in a recovery phase, that includes regulating the output voltage according to a first level and subsequently regulating the output voltage according to a second level of greater amplitude than the first level. The output regulated according to the second level is then subsequently supplied to the load.

Various aspects, advantages, features and embodiments of the present invention are included in the following description of exemplary examples thereof, which description should be taken in conjunction with the accompanying drawings. All patents, patent applications, articles, other publications, documents and things referenced herein are hereby incorporated herein by this reference in their entirety for all purposes. To the extent of any inconsistency or conflict in the definition or use of terms between any of the incorporated publications, documents or things and the present application, those of the present application shall prevail.

### BRIEF DESCRIPTION OF THE DRAWINGS

The various aspects and features of the present invention may be better understood by examining the following figures, in which:

FIG. 1a is a simplified circuit diagram of the charging half cycle in a generic charge pump.

FIG. 1b is a simplified circuit diagram of the transfer half cycle in a generic charge pump.

FIG. 2 is a top-level block diagram for a regulated charge pump.

FIG. 3 illustrates a charge pump of the prior art.

FIG. 4 illustrates a voltage multiplier stage of the prior art.

FIG. 5 illustrates the voltage output of a typical charge pump of the prior art.

FIG. 6 illustrates the voltage output of a pump in the recovery and regulation modes.

FIG. 7 is a box diagram of a charge pump system having three pumps.

FIG. 8 shows the cumulative charge pumped by the arrangement of FIG. 7 when enabled.

FIG. 9 illustrates some of the various signals involved when the pump system of FIG. 7 is in regulation.

FIG. 10 is a box diagram for an exemplary embodiment of a multiple charge pump system with delay enable.

FIG. 11 shows the cumulative charge pumped by the arrangement of FIG. 10 when enabled.

FIG. 12 illustrates some of the various signals involved when the pump system of FIG. 10 is in regulation.

FIG. 13 is a schematic illustration of a typical charge pump system and the phenomenon of overshoot during recovery.

FIG. 14 is a schematic illustration of an exemplary embodiment and its behavior during a 2-phase recovery process.

FIG. 15 shows the overshoot behavior during recovery in an actual charge pump system.

FIGS. 16 and 17 show two examples of a two phase recovery.

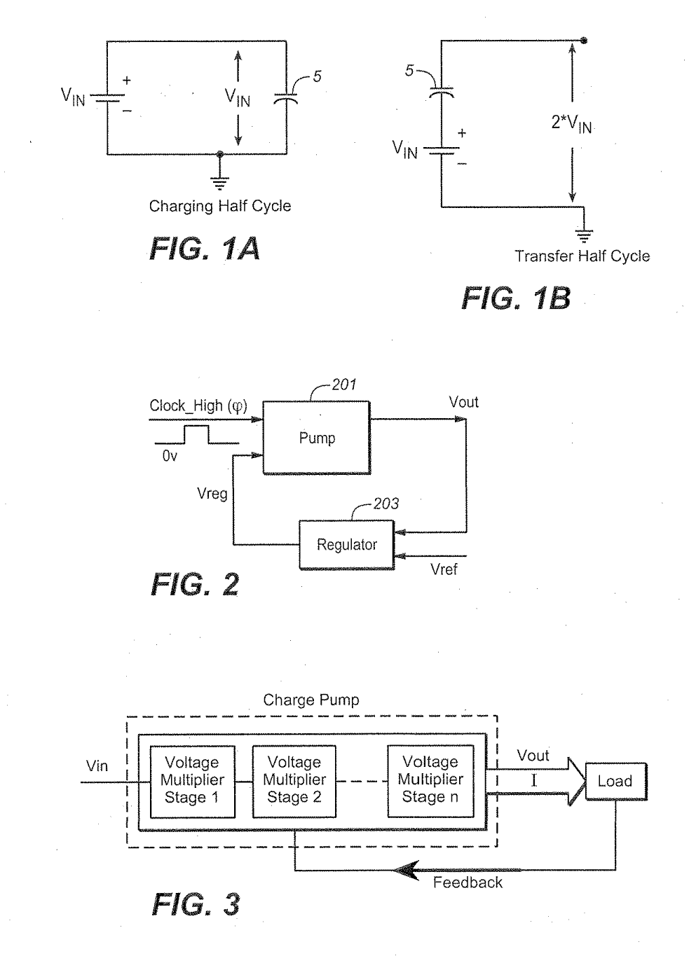

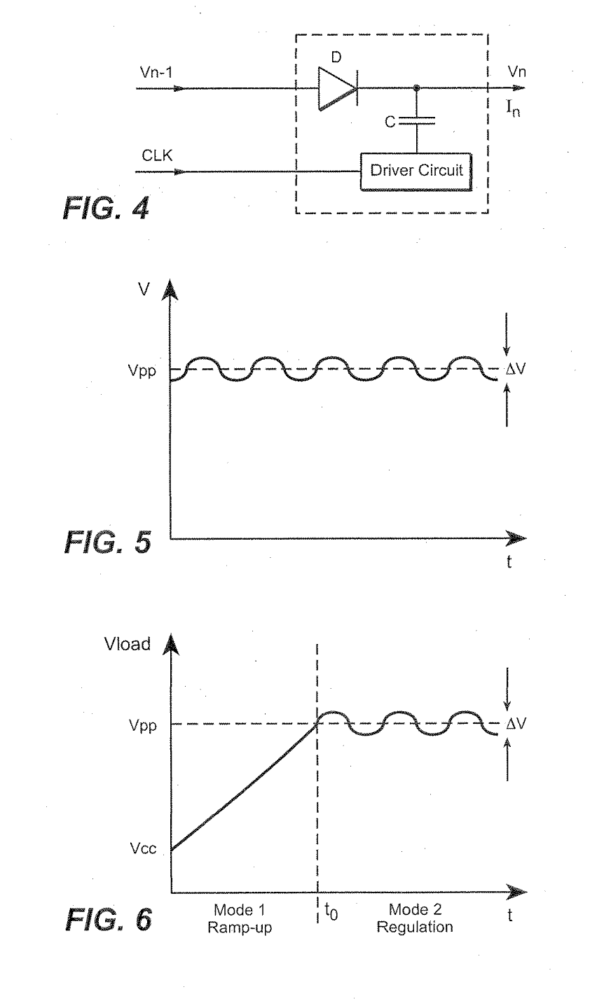

### DETAILED DESCRIPTION

To be adaptable to multiple purposes (loads and voltages), one relatively large charge pump is divided up into several smaller charge pumps connected in parallel to provide their individual outputs together as a combined output. To reduce the amount of ripple at the output during regulation, the multiple pumps are not all immediately enabled, but some are delayed and only enabled if the initial output is insufficient to drive the load at the regulation level.

More information on prior art charge pumps, such as Dickson type pumps, and charge pumps generally, can be found, for example, in “Charge Pump Circuit Design” by Pan and Samaddar, McGraw-Hill, 2006, or “Charge Pumps: An Overview”, Pylarinos and Rogers, Department of Electrical and Computer Engineering University of Toronto, available on the webpage “www.eecg.toronto.edu/˜kphang/ece1371/chargepumps.pdf”. Further information on various other charge pump aspects and designs can be found in U.S. Pat. Nos. 5,436,587; 6,370,075; 6,556,465; 6,760,262; 6,922,096; 7,030,683; 7,554,311; 7,368,979; and 7,135,910; US Patent Publication numbers 2009-0153230-A1; 2009-0153232-A1; and 2009-0058506-A1; and application Ser. Nos. 11/295,906 filed on Dec. 6, 2005; 11/303,387 filed on Dec. 16, 2005; 11/845,939, filed Aug. 28, 2007; 12/144,808 filed on Jun. 24, 2008; 12/135,948 filed Jun. 9, 2008; 12/146,243 filed Jun. 25, 2008; 12/337,050 filed Dec. 17, 2008; 12/506,998 filed on Jul. 21, 2009; and 12/570,646 filed on Sep. 30, 2009. In particular, U.S. Pat. No. 6,734,718 presents complementary ripple reduction techniques.

Charge pumps often operate in two modes, ramp-up or recovery mode and regulation mode. FIG. 6 illustrates the voltage on the load in these two modes of operation. Mode 1 is the ramp-up or recovery mode during which the load is brought to a predetermined voltage. (The Mode 2 region is similar to FIG. 5.) This requires a large current to charge the load to the required voltage as rapidly as possible. The figure shows an example of charging up a load (e.g. a wordline) from V_{cc}, to Vₚₚ in a time t₀. Mode 2 is the regulation mode during which the voltage is held as closely as possible to the required voltage, Vₚₚ. That is, ΔV in FIG. 6 is made as small as possible. (This requires a smaller current because a large current deposits a large quantum of charge each time the pump is turned on.

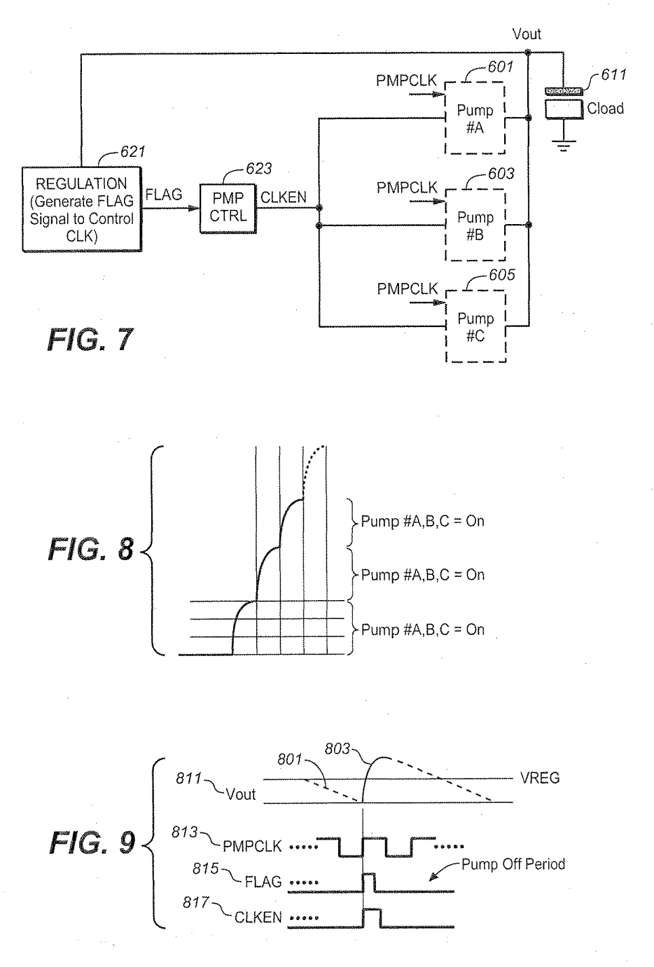

FIG. 7 is a box diagram of a charge pump system having three pumps, Pump A 601, Pump B 603, and Pump C 605 each receiving the clock signal PMPCLK and that are connected in parallel to drive the, in this example, capacitive load Cload 611. The output level is also fed back to the regulation element 621, which generates a flag telling the pump control circuit 623 to provide the clock enable signal CLKEN to the pumps when these are to be turned on. The use of three pumps allows the output to be adapted to the load.

In this example, the three pumps are connected in parallel and enabled by the same CLKEN signal to deliver charge to the output. Since they are controlled simultaneously by the signal CLKEN, when this signal is asserted all three will drive the load, which can lead to a potential overshoot and resultant high ripple level. The resultant waveform in such open regulation is, shown in FIG. 8, which shows the cumulative charge sent to the node marked Vout on FIG. 7. In regulation mode starting when the pumps are enabled (CLKEN asserted), in each cycle (indicated by the vertical dotted line) the amount of charge bracketed at right is supplied to the output node. The horizontal dotted line show the amount each pump contributes in the first cycle, which in this example are taken to be equal.

FIG. 9 illustrates an example of some of the various signals involved in regulation and corresponding Vout value. The specific waveforms shown are Vout 811, PMPCLK 813, FLAG 815, and CLKEN 817. For the Vout waveform 811, the lower line shows the voltage which will trigger the pumps coming back on and the upper line is where the pump will be disabled, as the voltage has passed the desired level. The waveforms begin with the Vout voltage on the load decreasing as shown in 801, decreasing until it reaches the lower level. This will cause the regulation element 621 to assert FLAG 815, with the pump control 623 in turn asserting CLKEN 814. Here, these are all shown to coincide with a rising edge of the PMPCLK single 813. Once the pumps are enabled, the supply charge to the output node. As shown in FIG. 8 at 803, during regulation, within one clock edge, they may be capable of delivering more than required charge to keep in regulation. As the single cycle causes the upper Vreg value to be exceeded, the pump is disabled, the level are Vout drops off and the process is repeated. Consequently, a high degree of ripple can result.

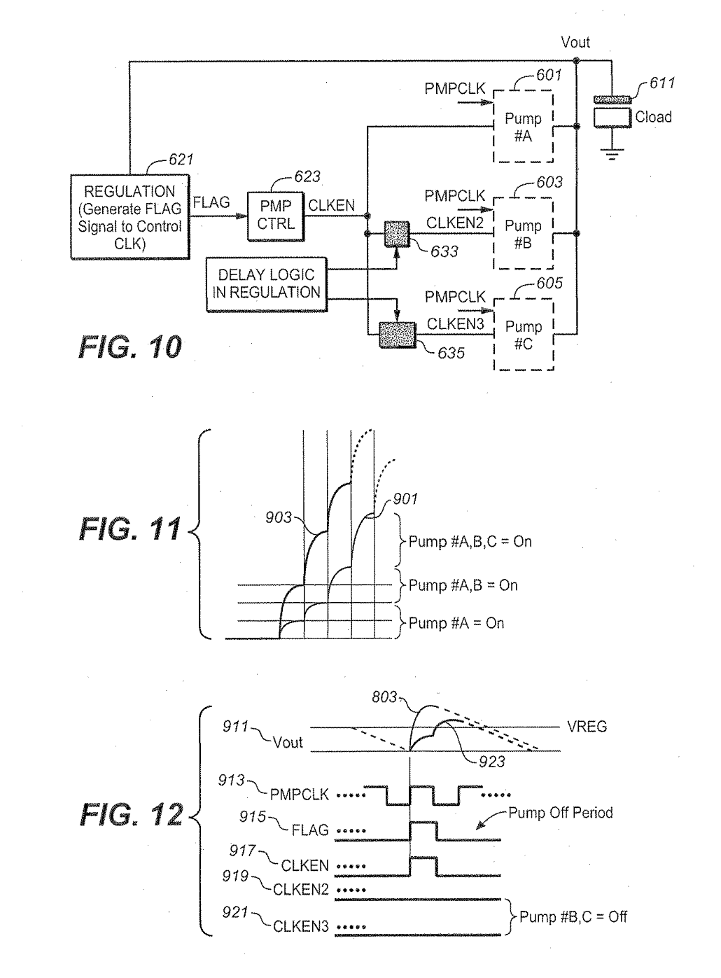

FIG. 10 presents an exemplary embodiment to illustrate some of the aspects presented here. As shown there, with the exception of elements 633 and 635, equivalents elements are arranged in the same way. The exemplary embodiment again shows three charge pumps (#A 601, #B 603, #C 605), but more generally the concept can be applied to any multiple number of pumps, whether 2, 3, or more. The charge pumps themselves can be of any of the various designs, such as those presented in the various references noted above, and not all of the pumps in the system need be of the same design. Here they are taken to of the same type, to have the same output, and to have same PMPCLK signal received in phase, but more generally any of these could be different.

To reduce the amount of ripple with respect to FIG. 7, a delay logic is enabled during regulation. This is implemented by the delay elements 633 and 635. As shown in FIG. 10, Pump #A 601 is controlled by the original CLKEN signal; Pump #B 603 is controlled by some delay time from CLKEN signal due to delay element 633; and Pump #C 605 is controlled through 635 by some longer delay time than B (illustrated schematically by the larger size of 635) from CLKEN signal. Depending on the embodiment and configuration, the amount of relative delay between the various delayed stages (here two, #B and #C) can be taken the same or different and can be preset, user configurable, or even dynamically adaptable. For the example here, 633 will have a delay of two cycles and 635 will have a delay of two cycles.

The idea is that in order to raise the output voltage from the level which will trip the regulation into enabling the charge up to the desired regulated voltage, the use of all three pumps may be too much, as has been described with respect to FIGS. 7-9. Instead, the embodiment of FIG. 10 initially only invokes one of the pumps, reducing the potential for overshoot; should this not be enough, a second pump will start, followed, if needed, by the third. This provides a more incremental approach to the desired level during the regulation mode.

FIG. 11 shows an example of the cumulative charge pumped to the output node under this arrangement during open regulation at 901. The waveform from FIG. 8 is also superimposed at 903 for comparison. In the first two clock pulses (separated by the vertical lines) after the pump the enable signal is asserted, only pump #A 601 is enable, supplying the quantity of charge indicated by the horizontal lines. If this is not sufficient to bring the output up to the regulation level, pump #B 603 is enabled, with pump #C605 following in the next cycle. Thus, if needed, all three pumps will eventually be enabled to drive the load.

In term of regulation, this is as shown in FIG. 12. The waveforms 913, 915, and 917 are much the same as their counterparts in FIG. 9; however, the CLKEN is now only supplied to Pump #A 601. During the first two clock pulse, only the one pump is enabled and the other two are off the exemplary embodiment. Consequently, the CLKEN2 919 and CLKEN 3 921 are not asserted. As shown at top in 911, since these two cycles are enough to bring the output voltage 923 up to the regulation value in the example, the other pair of pumps will not be needed for the load being driven. This example shows that something like a third of the original ripple (superimposed at 803) is reduced.

### Reduction of Overshoot During Recovery and Ramp-Up

As discussed above, during the ramp-up or recovery phase the output of the charge pump typically overshoots the desired level of regulation for the output voltage. After a large capacitive load is connected to the output, the voltage level at the pump's output drops and recovery begins, with the output ramping up until the desired regulation level is reached, as shown above with respect to FIG. 6. Due to the finite delay in the feedback path, by the time the regulation circuitry registers that the desired regulation level has been reached, the current output level will have been over corrected. For the elements being supplied by the charge pump, this can result in reliability concerns and breakdown in components as they are overstressed. There are various techniques to deal with such overshoot (speeding up the feedback path, controlling clock frequency, power input, etc.), these techniques are typically at odds with other design constraints.

It should be noted that whereas the previous section was concerned with ripple during regulation, this section is concerned with the sort of overshoot that can occur during ramp-up or the recover mode. When the circuit is in the regulation phase, there will some (typically fairly small) swing in the output level. Due to the finite delay in the feedback path, there is a lag in detection of the output level and a resultant over-correction. This leads to the sort of ripple or regulation noise discussed above, but the amount of over-correct is typically not significant in a well regulated system. However, where the output voltage differs significantly from the desired target level, such as occurs when the pump is initially connected to drive a load, the op-amp or comparator of the regulation circuitry is tempted to over-correct the error of the output voltage and dump excess power into the system. Again due to the finite delay in the system's feedback, this leads to overshoot in the regulation process, an overshoot that is generally larger than that found in the ripple or regulation noise when the pump is in the regulation phase.

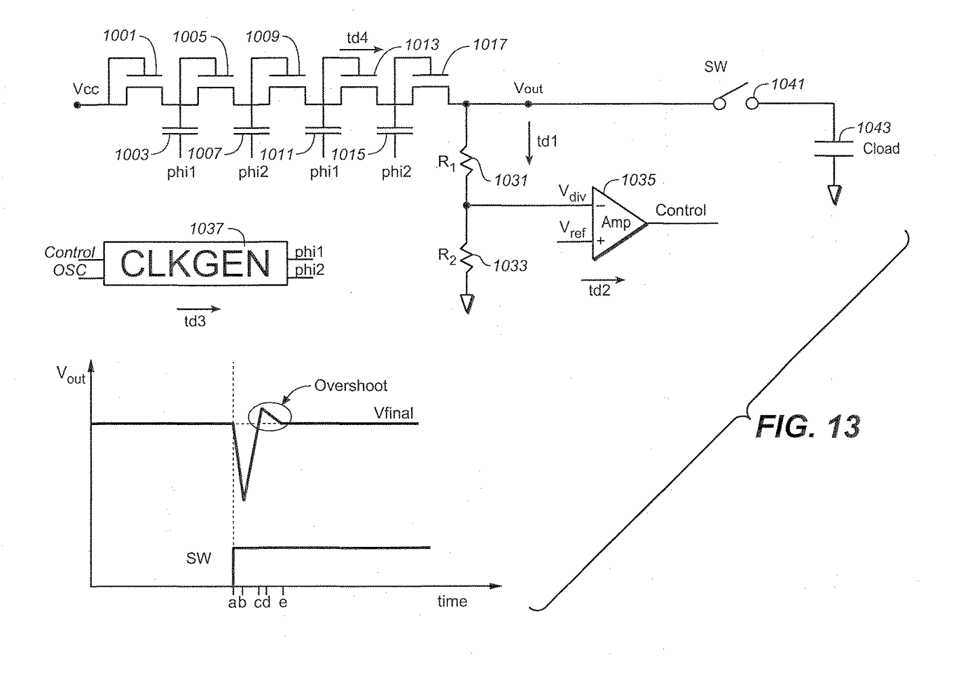

Overshoot phenomena can be illustrated further with respect to FIG. 13, the top part of which shows a schematic illustration of a charge pump system and the bottom part of which shows the response when a load is applied. The upper left portion of FIG. 13 shows a charge pump, here a 4-stage Dickson-type pump receiving an input voltage Vcc and generating from it the output voltage Vout. The diode connected transistors 1001, 1005, 1009, 1013, 1017 are arranged in series with one of the capacitors 1003, 1007, 1011, 1015 having its top plate connected between a corresponding pair of the diodes and the bottom plates of the capacitors alternately receiving one of a pair of clock signals phi1 and phi2. The output of the pump can then be connected by the switch SW 1041 to drive a load, here represented by the load capacitor Cload 1043. Vout is also supplied to the regulation circuitry.

The regulation circuitry is here represented by Amp 1035, where a first input is fed a reference voltage value Vref (from a bandgap circuit, for example) and a second input is fed with a value derived from Vout. Here the second input in taken from a node between the resistive elements R₁ 1031 and R₂ 1033 connected in series between Vout and ground. (More generally, the voltage divider for this feedback path can also be capacitive or other combinations of elements.) Based on the value at this node relative to Vref, the circuitry generates a control signal Control, which is then used to regulate the output. In this example, this is done by supplying Control to the clock generating circuit CLKGEN 1037. CLKGEN 1037 also receives as an input an oscillator or clock signal OSC and, based on these inputs, generates the clock signals phi1 and phi2 used to drive the charge pump. Based on Control, CLKGEN 1037 could, for example, vary the amplitude or frequency of phi1 and phi2.

The regulation is based the current level of Vout, but when the level of Vout changes the result of the regulation will lag due to the finite delays through regulation path, clock generation, supply voltage regulation, and so on. For example, as shown in FIG. 13 when Vout changes there will be a delay td1 from the output node to the input of Amp 1035, a delay td2 as Control is generated and propagated to the clock generation circuit, a delay td3 through CLKGEN 1037, and then a delay of td4 as the newly regulated clock signal propagate the output through the pump itself to the output node. This can lead to an overcorrection of the regulation and significant deviation from desired regulated voltage level, as illustrated in the plot of Vout versus time.

Prior to driving the load, the switch SW 1041 is open (the corresponding control signal SW is low) and Vout is initially being held at the regulation level. At a time ta, the control signal SW is asserted, the corresponding switch SW 1041 closed, and the output of the pump applied to the load. Correspondingly, Vout drops as the load is driven and there will also be a delay as this drop propagates though the delays td1, td2, td3, and td4 until Vout begins to ramp up at tb. The recovery phase continues until, at tc, Vout obtains the desired regulation level of Vfinal. However, by the time Vfinal is reached and this information and the corresponding recovery to regulation change is propagated though the system, Vout has continued ramping up until td, overshooting Vfinal. At this point, Vout then drops back down until the system goes into regulation mode at te. (Once in regulation there will also be ripple as discussed above and developed further in U.S. patent application Ser. No. 12/146,243 filed Jun. 25, 2008, but this will be overlooked for the purposes of this section.) This voltage overshoot can lead to damage in circuit elements being supplied by the pump as the Electrical Design Rule (EDR) is violated, stressing the load and possibly causing gate/junction breakdown.

The techniques presented here treat this overshoot problem through use of a two-stage recovery process. If, when the load is connected, the voltage drops to a level significantly lower than the desired target level (Vfinal), the pump is regulated based on an initial, lower target regulation level Vstart, Vstart=Vfinal−delta V. (For example, if Vfinal is 4V, delta V could be 200 mV—the value of delta V is usually based on the specific circuit design, the amount of overshoot will vary from design to design.) Once the output voltage hits Vstart, the system changes the target regulation to Vfinal. In the initial part of the recovery phase based on the Vstart, as any overshoot is relative to this lower level, it will be lower; and as the difference between Vstart and Vfinal is relatively small, the overshoot during the incremental additional ramp-up after raising the regulation level to Vfinal will produce a smaller deviation in the second recovery phase as well. Consequently, the over-correction due to the voltage difference from final target level during recovery is minimized. If, on the other hand, the drop in Vₒᵤₜ is relatively small, this will typically not lead to significant overshoot and the initial phase need not be invoked.

Relative to other approaches, this two-stage ramp-up or recovery can also lead to a reduction of the delay through the regulation path. When regulating a voltage supply, the specification typically specifies that the output level can vary by a certain amount, say ±10%. One way for dealing with such overshoot is to detect how close the voltage is to the final regulation level and then slow down the pump clock to reduce the output power of charge pump. Doing so causes an extra delay. Under the two-phase arrangement given here, the output is given a margin to allow overshoot in the first phase, so that there is no need to slow the system down while still allowing it to fall into the desired range (i.e., ±10%). Subsequently, the regulation level is changed to the second regulation level, and all known techniques to reduce output noise can then be applied. In this way, during the first phase the system can operate at full speed and still end up in the desired range while still avoiding the design rule (EDR) concerns.

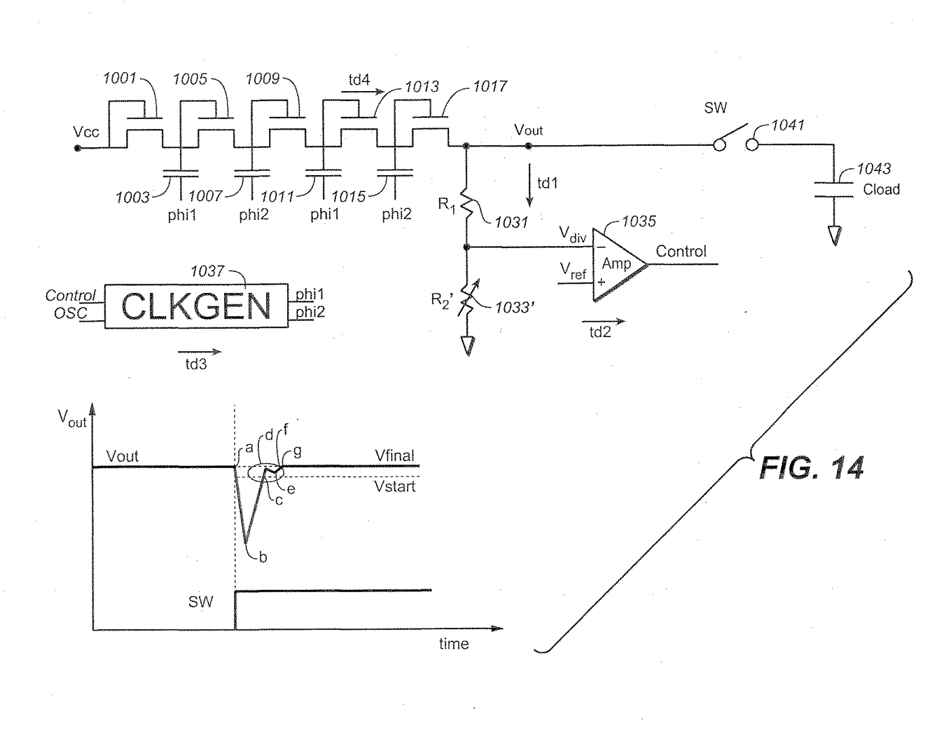

FIG. 14 illustrates an exemplary embodiment for implementing such a 2-stage recovery process. The upper part of FIG. 14 again shows a charge pump as in FIG. 13 with the corresponding elements similarly numbers and the lower part shows behavior at the output as a function of time. Relative to FIG. 13, R′₂ 1033′ is now a variable resistance that, in this example, has 2 discrete values, allowing the input of the amp (or, more generally, comparator) 1035 connected to the node above R′₂ 1033′ to be set at two different values relative to the level on Vout. The higher value of R′₂ 1033′ corresponds to Vfinal of the desired, final regulation level used in the second phase of recovery and would have the same value as for R₂ 1033 in FIG. 13. The lower value of R′₂ 1033′ corresponds to the initial phase of recovery based on Vstart. When the pumps system goes into recovery mode, the regulation circuitry starts with R′₂ 1033′ at the lower value corresponding to the Vstart and, aside from the lower target value for Vout, the recovery process larger proceeds in the usual way. Once the output has recovered to the initial Vstart level, the R′₂ 1033′ switches to the higher value corresponding to actual desired target level of Vfinal for the second recovery phase. As before, in other embodiments the resistances Rₐ and R′₂ can be replaced or used in conjunction with capacitive or other elements.

The level of Vout versus time for this two stage recovery is shown at bottom left in FIG. 14. As in the corresponding part of FIG. 13, prior to driving the load, the switch SW 1041 is open (the corresponding control signal. SW is low) and Vout is initially at the (final) regulation level corresponding to Vfinal. At a time t′a, the control signal SW is asserted, the corresponding switch SW 1041 closed, and the output of the pump applied to the load. Correspondingly, Vout drops as the load is driven and there will also be a delay as this drop propagates though the delays td1, td2, td3, and td4 until Vout begins to ramp up at t′b. The first phase of the recovery is based on Vstart using the lower value of R′₂. The first recovery phase continues until, at t′c, Vout reaches Vstart. As before, by the time Vstart is reached and this information and the corresponding regulation change is propagated though the system, Vout has continued ramping up until t′d, overshooting Vstart. At this point, Vout then drops back down until t′e. Although there is again overshoot, the overshoot at t′d is relative to Vstart, rather than an overshoot relative to Vfinal, so that peak level at Vout is lowered.

Once the information that Vout has reached Vstart at t′c, the regulation level switches to Vfinal for the second phase of recovery. There can be a finite delay between switching from the first regulation level to the second regulation level, with (in the embodiment of FIG. 14) the value of R′₂ 1033′ being changed to correspond to Vfinal. (As the overshoot is a characteristic of the finite delay in the feedback path, and the over-correction is due to large output deviation from target value, the system may also switch right after hitting Vstart, since between Vstart and Vfinal, the voltage difference is smaller compared with initial voltage difference. If the design is done properly, the output should not be over-corrected, and should have much less noise.) Within this period, Vout drops back down from the first phase's overshoot before it begins to ramp back up in the second recovery phase at t′e. The system then recovers to Vfinal. There may again be some overshoot in this second phase, but this is relatively small since no significant over-correction is happening in the second regulation phase. In the embodiment of FIG. 14, where the regulation level is set by varying the value of R′₂ 1033′, the value of this resistance is set and changed by the regulation circuitry based on a detection from the comparator AMP 1035. For other implementations, the output of comparator can similarly be used to perform this switching.

Although the preceding discussion, as well as that which follows, is based on a charge pump for generating a positive output voltage, the same techniques can readily be applied to for pump systems that generate negative regulated voltages. Such systems are known and are regulated much as discussed above, but with, roughly speaking, the various levels involved inverted with respect to ground. For example, in the case of the negative charge pump, the behavior shown by Vₒᵤₜ in the lower part of FIG. 13 would again be exhibited, but in this case the values would be negative and what is being shown would be the magnitude of Vᵥₒᵤₜ, |Vᵥₒᵤₜ|=−Vₒᵤₜ. In particular, the same overshoot phenomena would be exhibited as shown, except the output would now go too negative. Consequently, the negative pump situation can be addressed again as described with respect to the lower part of FIG. 14 using a two-phase or -stage regulation during recovery or ramp-up (or, perhaps, “ramp-down” in this case). The first stage of recovery would use a first regulation level less negative (or lesser amplitude) than that of the second stage, which would use the regulation of the desired final level of regulation.

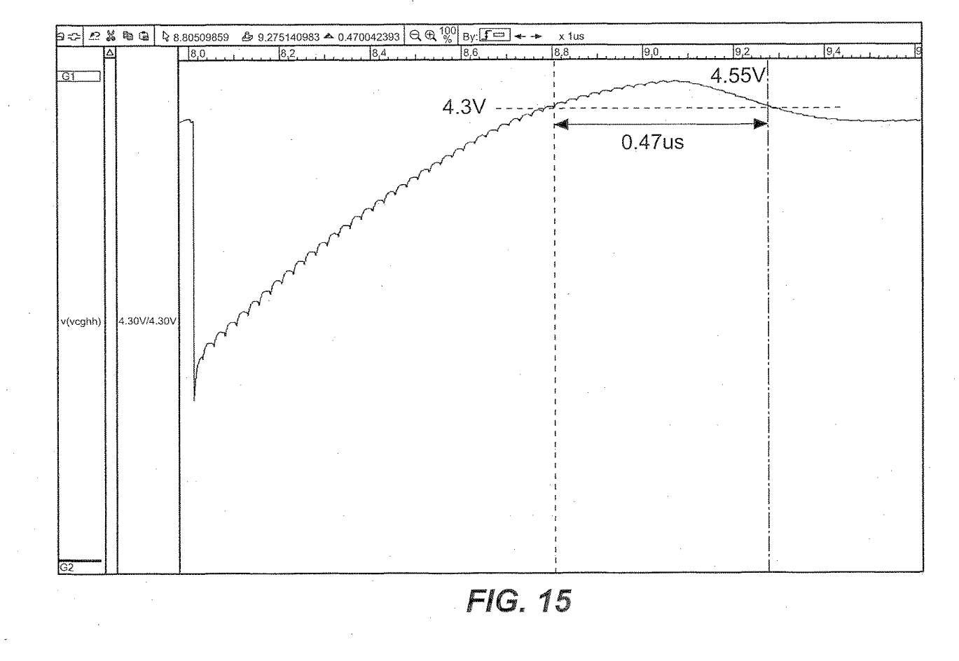

FIGS. 15-17 illustrate the actual behavior of a pump system for one stage and two stage recovery. FIG. 15 is a one phase recovery process and the desired Vout level is 4.2V, although electric design rule (EDR) is approved for 4.3V in some corners. As the trace shows, after the load is connected, Vout drops down and recovery begins. Before settling to the regulation level of 4.2V, the overshoot occurs, having a maximum value of 4.55 V, exceeding 4.2V for 0.62 us and 4.3V for 0.47 us. This exceeds the EDR and can place significant stress on the load.

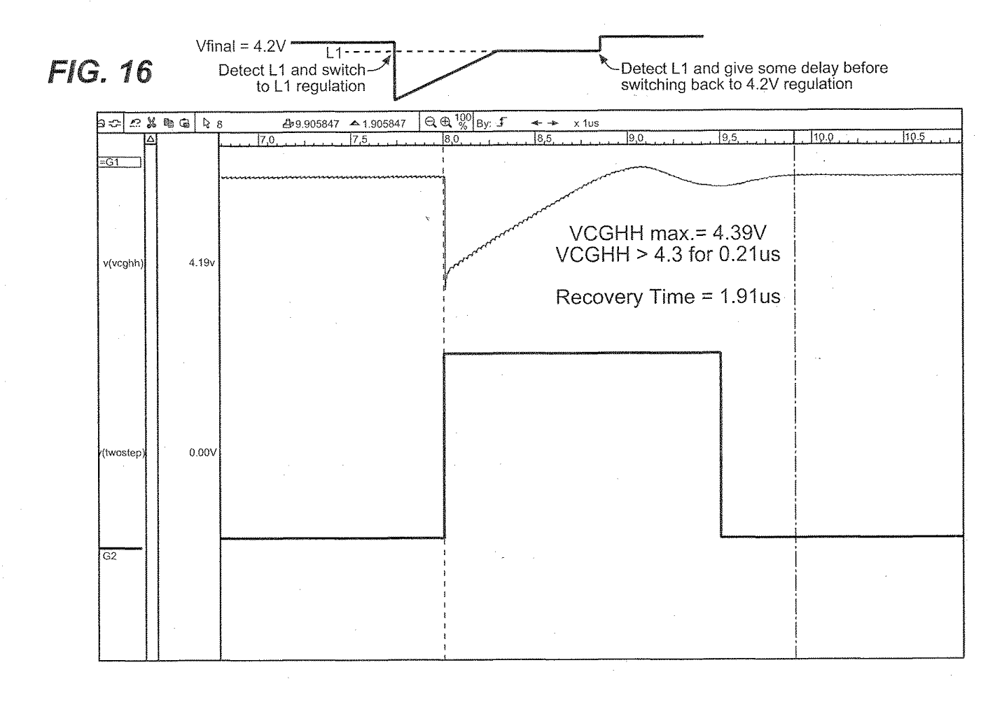

FIG. 16 illustrates a two phase recovery. Vfinal is again 4.2V and Vstart is taken as 4.0V. The top portion of FIG. 16 schematically illustrates the two phases: once Vout drops below L1=Vstart, the regulation switches to regulation based on this initial level and recovery begins. Once the level L1 is reached, after some delay, the regulation is switched to Vfinal for the final, relatively small, phase of recovery. An actual trace of this behavior is shown in the lower portion of FIG. 16, where the bottom trace shows signal controlling when the lower level of regulation L1=Vstart is being used. In this example, Vstart=4.0V. The top trace is Vout. Once the load is connected, Vout drops below 4.0V, the L1 control signal is asserted, and recovery based on the a 4.0V regulation level is used. The output ramps up and after the output initial reaches 4.0V, after a delay to let the overshoot drop back, the L1 control signal is de-asserted and the regulation is then based on Vfinal=4.2V. The amount of delay can be preset or trimable. In this example, the maximum. Vout is reduced to 4.39V (as opposed to 4.55V in FIG. 15) and 4.3V is exceeded for 0.21 us (compared to 0.47 us in FIG. 15). The full recovery time for both phases is 1.91 us.

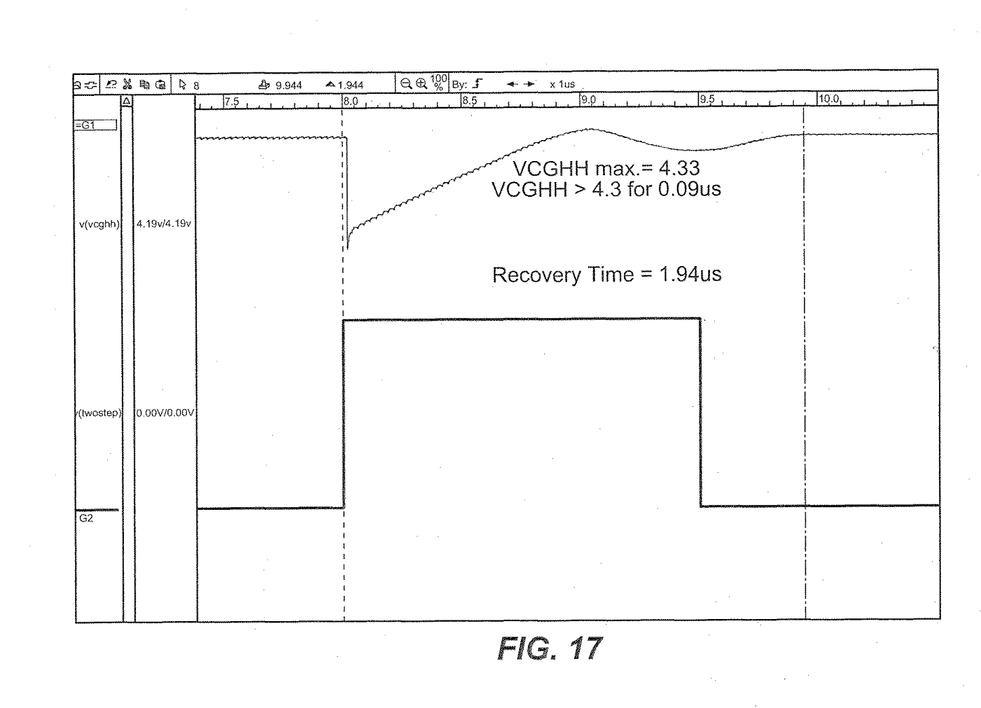

FIG. 17 corresponds to the lower portion of FIG. 16, but with Vstart=3.9V. In this case the maximum value of Vout is 4.33V and Vout exceeds 4.3V for 0.09 us. The full recovery time for both phases is 1.91 us. In all these cases, the system will then operate in regulation mode based on Vfinal.

The discussion here was based on a Dickson-type pump, using a two stage recovery, and where the regulation is effected through the clock circuitry, but the techniques are more generally applicable. For example, they can be applied to other pump types (such as voltage doublers) and other methods of regulation (such as varying clock frequency, clock amplitudes, input voltages, number stages, and so on), such as those described in the various references cited above. Similarly, instead of using of two discreet regulation levels, more levels can used or even a continuously varied regulation level. The differing regulation levels can also be implemented in a number of ways: in FIG. 14, the value of R′₂ 1033 is varied, but alternately the value of R₁ 1031 or Vref could be varied, for example.

Although the invention has been described with reference to particular embodiments, the description is only an example of the invention's application and should not be taken as a limitation. Consequently, various adaptations and combinations of features of the embodiments disclosed are within the scope of the invention as encompassed by the following claims.

1. A charge pump system for supplying an output voltage to a load, comprising:
a charge pump connected to receive an input voltage generate therefrom the output voltage;
regulation circuitry connected to receive the output voltage and a reference voltage, the regulation circuitry connected to the charge pump to regulate the output voltage based upon the values of the reference voltage and the output voltage,
wherein during a recovery operation, the output voltage is initially regulated according to a first level and subsequently regulated to a second level of greater amplitude than the first level, the second level corresponding to a desired regulated output voltage.

2. The charge pump system of claim 1, wherein the regulation circuitry generates a control signal based upon the values of the reference voltage and the output voltage, the charge pump system further comprising:
a clock generation circuit connected to receive the control signal and an oscillator signal and generate therefrom a clock signal dependent upon the control signal, wherein the charge pump is connected to receive the clock signal and generates the output voltage based on the clock signal.

3. The charge pump system of claim 2, wherein the frequency of the clock signal is dependent upon the control signal.

4. The charge pump system of claim 2, wherein the amplitude of the clock signal is dependent upon the control signal.

5. The charge pump system of claim 1, wherein the regulation circuitry includes:
first and second elements connected in series between the output voltage and ground;
a comparator having a first input connected to receive the reference voltage, having a second input connected to a node between the first and second elements, and generating as output a control signal having a value based upon the first and second inputs, wherein the charge pump is regulated based upon the value of the control signal.

6. The charge pump system of claim 5, wherein one or more of the first and second elements are resistances.

7. The charge pump system of claim 6, wherein the value of one of the elements has a first value when regulating according to the first level and a second value when regulating according to the second level.

8. The charge pump system of claim 5, wherein one or more of the first and second elements are capacitances.

9. The charge pump system of claim 1, wherein the charge pump has a Dickson-type pump structure.

10. The charge pump system of claim 1, where the first and second levels are positive voltage levels, the second level being higher than the first level.

11. The charge pump system of claim 10, wherein the regulation circuitry regulates the charge pump according to the first level in response to the output voltage dropping below the first level and regulates the charge pump according to the second level in response to the output voltage rising above the first level.

12. The charge pump system of claim 11, wherein, subsequent to the output voltage rising above the first level, the regulation circuitry continues to regulate the charge pump according to the first level for a delay period before regulating the charge pump according to the second level.

13. The charge pump system of claim 1, where the first and second levels are negative voltage levels, the second level being more negative than the first level.

14. A method of operating a charge pump system to provide an output voltage at an output, comprising:
applying a load to the output;
in response, operating the charge pump in a recovery phase, including:
regulating the output voltage according to a first level; and
subsequently regulating the output voltage according to a second level, the second level being of a greater amplitude than the first level; and
subsequently supplying the load with the output regulated according to the second level.

15. The method of claim 14, where the first and second levels are negative voltage levels, the second level being more negative than the first level.

16. The method of claim 14, where the first and second levels are positive voltage levels, the second level being higher than the first level.

17. The method of claim 14, wherein the charge pump operates in the recovery phase response to the amplitude of output voltage dropping below the amplitude of first level.

18. The method of claim 14, the recovery phase further comprising:
while regulating the output voltage according to the first level, detecting that the output voltage has reached the first level, wherein the output voltage is regulated according to the second level in response to detecting that the amplitude of the output voltage has reached the first level.

19. The method of claim 18, wherein, subsequent to detecting that the amplitude of the output voltage has reached the first level, the output voltage is regulated according to a first level for a delay before regulating the output voltage according to the second level.
